(19) United States
(12) Patent Application Publication
(10) Pub. No.: US 2009/0281922 A1
(43) Pub. Date: Nov. 12, 2009

(54) METHOD AND SYSTEM FOR SELECTING CLOTHING ITEMS ACCORDING TO PREDETERMINED CRITERIA

(76) Inventors: Rhonda L. Childress, Austin, TX (US); Pamela Ann Nesbitt, Tampa, FL (US); Ori Pomerantz, Austin, TX (US)

Correspondence Address: IBM CORPORATION;C/O DARCELL WALKER, ATTORNEY AT LAW, P. O. Box 25048, HOUSTON, TX, 77265, US

(21) Appl. No.: 12/119,226

(22) Filed: May 12, 2008

(51) Int. Cl. G06Q 30/00; G06F 17/30; G06F 7/06; G06N 5/02

(52) U.S. Cl. 705/27; 707/5; 706/47; 707/E17.014

(57) ABSTRACT

A method and system enables users to select clothing choices for various situations such as: 1) During the purchase of new clothing items; 2) when deciding what to pack for a trip, possibly to a different culture; 3) when deciding what to wear for a particular occasion, or what to pack for a trip. In this invention, a database contains information about a client's wardrobe. Each item in the database is placed in a defined category and has a unique identity. The user can enter certain search requirement that enable the invention to search the clothing database for clothing matches that are consistent with the search requirements.

### FIELD OF THE INVENTION

This invention relates to a method and system for selecting items of clothing. In particular, it relates to a method and system for selecting items of clothing for particular weather conditions and for particular cultural settings.

### BACKGROUND OF THE INVENTION

The process of choosing clothing items can be a science or art for many people. With all of the fashion rules that govern what people should wear, when they should wear it and where certain clothing items should be worn can make the process of selecting clothing for a particular situation difficult. On a less regular basis, this selection problem occurs in an even larger form when it comes to buying clothes, shoes or accessories. The combinatorial explosion that results from having to choose a blouse and trousers that fit together (and that fit to the already existing wardrobe) from the vast assortment of a fashion shop is huge.

The daily process of getting dressed, therefore, amounts to selecting one possibility out of an enormous selection of items. There are numerous factors that influence a person's selection of clothing items. Some of these factors include:
Weather conditions (no thin blouses in Winter, unless under a woolen sweater; no short skirts when having to cycle in the rain).
Color and textile combination matches (brown shoes don't go well with bluish clothes, except for jeans).
Shape aesthetics (a long sweater and a short coat don't go together).
Fashion (depending on the fashion industry, certain color schemes are preferred in some periods).
Availability (can't wear things that are currently in the laundry).
Hygiene (shouldn't wear a single piece of clothing for too long).
Comfort (wearing clothes that do not irritate the skin).
Duties (tasks a person may have to perform).
Personal preference (what a particular person likes)

Current recommendations are made through systems such as billboards and advertisements on TV, and through fashion magazines and the likes. However, such recommendations are generic and not personalized. These facts make the recommendations inaccurate and have little use for most people. Clothing choices appear to have an unwritten code that is often difficult to decipher, especially for people who are color blind or visionally impaired or those who come from a different culture. This situation can have a negative impact, both socially and professionally. The retail industry is poised to offer services in order to sell more clothes. Telling people what is fashionable could potentially force more sales than waiting for the average man to notice fashion trends.

In addition to the many fashion rules that one attempts to follow, when people travel to other cultures, the attire in these cultures often differs from the culture of the visitor. In some cultures, the clothing items one wears are an indication of their religious or spiritual beliefs. When visitors are in a place, the native people can easily identify them by their attire. In some circumstances, this notoriety may be unwanted and unwelcome. As a result, there remains a need for a method and system that could assist persons traveling to different places in selecting items that are compatible with the culture and both social and physical environment of these places.

### SUMMARY OF THE INVENTION

The present invention describes a method and system for assisting a person in making clothing choices for various situations. These situations can include things such as: 1) During the process of purchasing new clothing items; 2) when deciding what to pack for a trip, possibly to a different culture; and 3) when deciding what to wear for a particular occasion. This invention includes a database that contains information about a user or client's wardrobe. Each item in the database has a unique identity and can be placed in a defined category. The unique item identities and the defined categories facilitate database searches as desired by the user. Once the user identifies certain search requirements, features of the invention have the capability to search the clothing database for clothing item matches that are consistent with the search requirements.

In the method of the invention, a user profile is created that contains information about the user's wardrobe including the clothing items that will be part of the initial wardrobe for that user. In this invention, a query is received from a user. This query can be a search request and can contain information describing the criteria for the search. The search of the wardrobe produces matches of clothing items that would be appropriate for the defined condition.

In an alternate method, a query is received from a user. This query can contain information describing the conditions that are the motivation for the query. For example, the conditions could be trip to a defined location, a trip with weather implications, or a potential clothing item purchase. After a determination of the appropriate conditions for the query, the method can determine search criteria and perform a search of the user's wardrobe file. In the case of a potential clothing item purchase, the user will probably provide part if not the entire search criterion. The search of the wardrobe produces matches of clothing items that would be appropriate for the defined condition. Finally, combinations of clothing items can be generated, from the matches that are appropriate for the defined conditions.

### DETAILED DESCRIPTION OF THE DRAWINGS

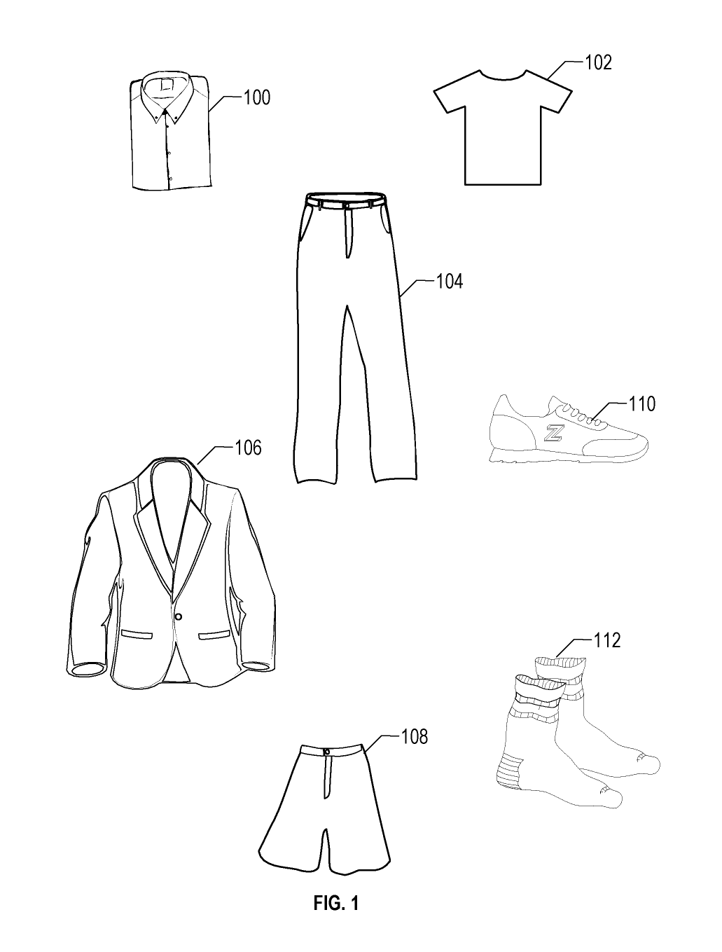

FIG. 1 is an illustration of clothing items that can be in a user's wardrobe and entered into the wardrobe database.

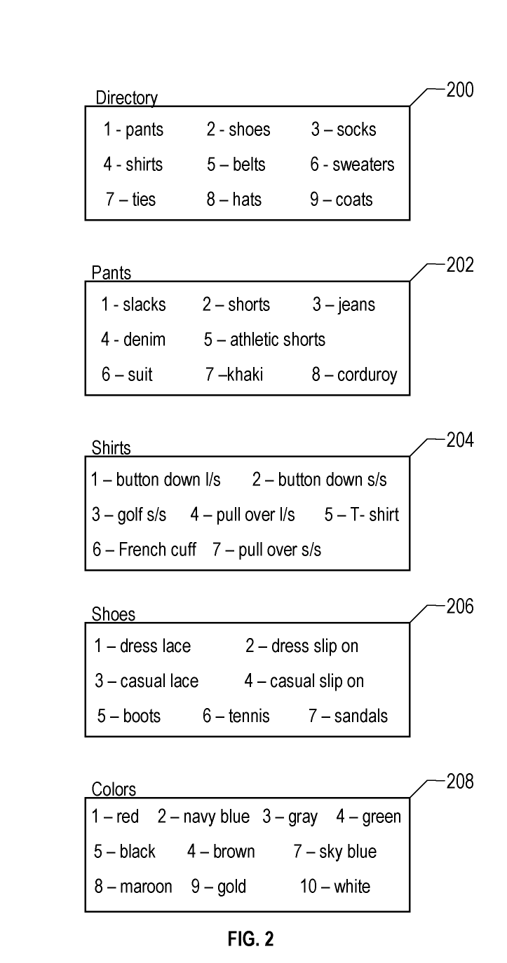

FIG. 2 is an illustration of a directory of clothing item identifiers in a wardrobe database.

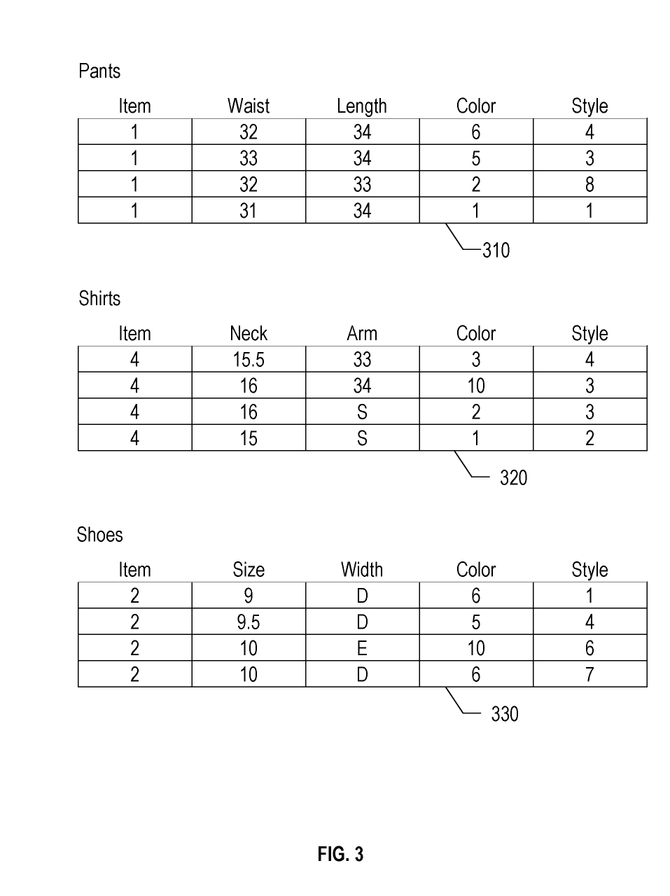

FIG. 3 is an illustration of set of records stored in a database that contain information about clothing items in the user's wardrobe.

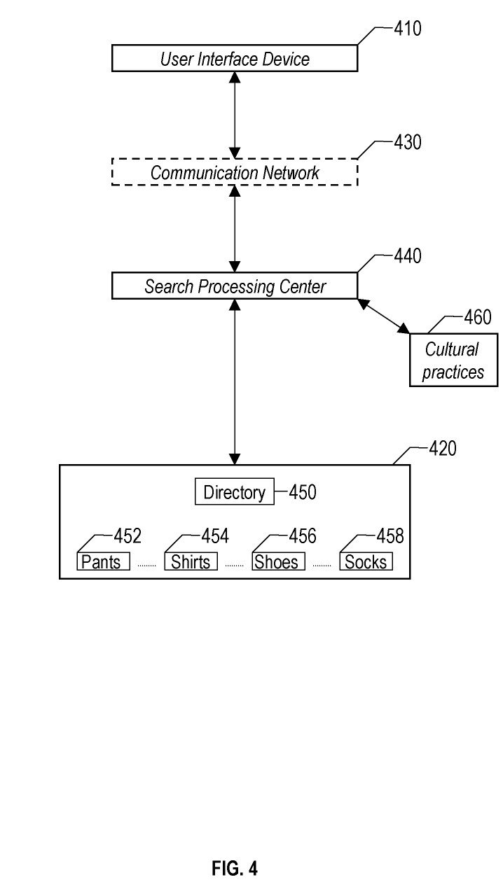

FIG. 4 is an illustration of a configuration of a system in accordance with the present invention.

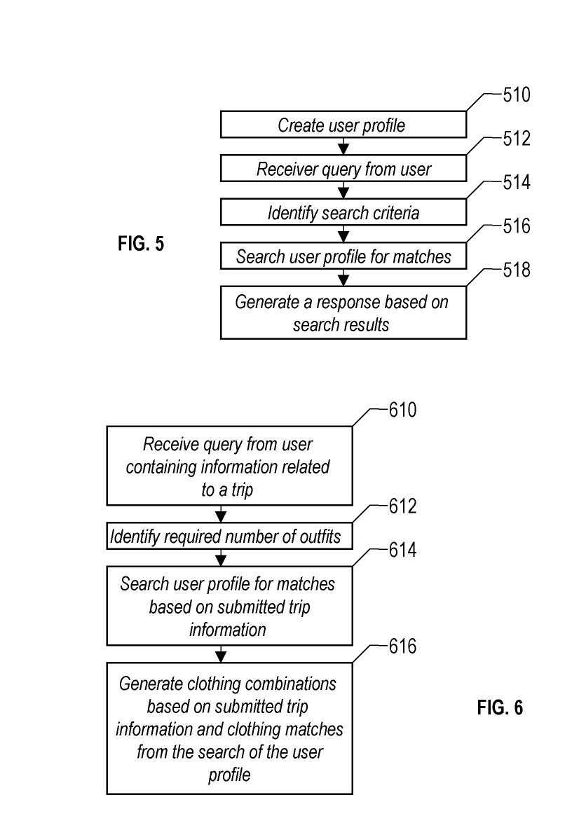

FIG. 5 is a flow diagram of the general steps in the implementation of the present invention.

FIG. 6 is a flow diagram of the general steps in the implementation of the present invention for planning and packing for a trip.

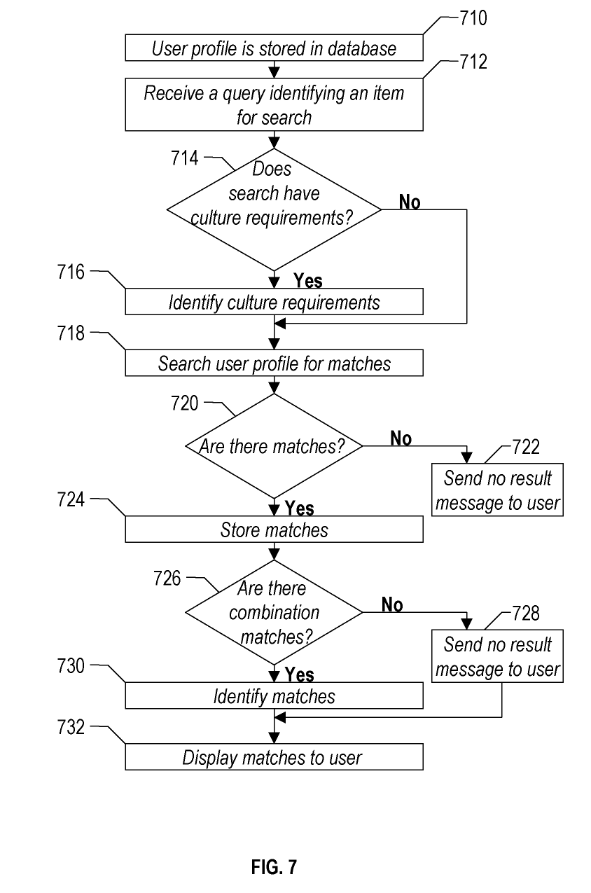

FIG. 7 is a flow diagram of a detailed implementation of the method of the present invention.

### DETAILED DESCRIPTION OF THE INVENTION

FIG. 1 shows various types of clothing items that a user can store information about in a database. As shown in FIG. 1, these clothing items can include a button down shirt 100, a tee shirt 102, pants 104, a suit coat 106, shorts 108, shoes 110 and socks 112. In addition to these items, a user can establish other categories of clothing items such as belts, purses or hats.

A user can establish his or her own database file containing items from the user's personal wardrobe. The database is programmed with clothing items that the user owns. The user can access the database and perform this programming task from any remote location via a computing network. Referring to FIG. 2, shown are sets of identifiers within subdirectories that one can use to describe various items in the user wardrobe database. The wardrobe directory 200 can have subdirectories for various categories of clothing items. In this illustration, also see FIG. 4, the subdirectories are pants 202, shirts 204, and shoes 206. The sub-directories contain indexes for the style of the clothing item. The colors index 208 is an inventory of colors used to identify colors of the various the clothing items.

FIG. 3 shows records of clothing items from a user's wardrobe that are stored in the database in the user's profile. The records have various fields that contain information about the specific type of clothing items. In the examples herein, each type of record of has five fields. The actual number of fields could vary for the individual clothing items. In the pants sub-directory 310, there are five fields: item, waist, length, color and style. In this database, referring to directory 200, each pants item has an identification code of “1”. The first entry is for a pair of pants that has a 32-inch waist, 34-inch length and has an identified color code of 6. From the color index 208, the number 6 is for brown. This pair of pants is brown. The style indicated by the number 4 from the pants subdirectory 202 is that the pants are denim pants. In the shirts sub-directory 320, there are five fields. However, some of the information in these records is different from the information in the pants records. In the records for the shirts there are fields for: item, neck size, arm length, color and style. The item indicator for shirts in directory 200 in the database is 4. In the first shirt record, the shirt has a neck size of 15.5 inches. The arm length for this shirt is 33 inches. The color field has the number 3. From the color index 208, the number 3 is for the color gray. This shirt is gray. The style field has the number 4. From the sub-directory 204, the number 4 indicates that the style of the shirt is a pull over long sleeve shirt. FIG. 3 also a sub-directory containing record entries for shoes 330. As with the types of clothing items, shoe entry items have fields with various information items that differ from the other clothing items. Again referring to directory 200, the number 2 in the item field indicates a shoe item. In the first record, the shoe size is a 9. The shoe width is a D. The color field contains the number 6. This number indicates from the color index 208, that the shoes are brown. The style field has the number 1, which is an indication that the shoe style is a dress lace shoe.

FIG. 4 shows a configuration of a system of the present invention. The user accesses, transmits information to and receives information from the system using a user interface device 410. This device will typically be some PDA type device or other electronic device. The user interface device can also be a computer terminal device. The interface device 410 accesses the clothing database 420 via a communication network 430. This network can be the Internet or some other widely used communication network. The system contains a search-processing center 440. This processing center receives the search queries, identifies the particular user making the search query and performs the search based on search criteria information in the query. As shown, the actual database 420 has a directory 450, which is an index of all of the sub-directories 452, 454, 456 and 458 in the database. The database can contain a sub-directory for each type of clothing item that will be listed in the database. As shown, in this database there are sub-directories for pants, shirts, shoes and socks. Each sub-directory will have a record entry for each item of clothing and a set of indexes relevant to that clothing item as shown and discussed in FIG. 3. This particular embodiment of the system shows a cultural practices module 460. This particular module can also be incorporated inside the search-processing center. The system can also have a separate module that focuses on weather conditions for particular locations. Similar to the cultural practices module, the weather module can be included inside the search-processing center or can be a stand-alone module. In addition to the particular culture and weather modules described herein, the system of the present invention can have the capability to access information related a particular culture or weather information from outside sources such as a website containing weather information.

One particular application of the system of the present invention is to be able to respond to queries related to appropriate dress based on the culture of a particular place. This cultural practices module 460 can contain rules to govern the selection of clothing items based on the culture of a location that the user will visit. When a query relates to culturally appropriate attire, this module will be used in generating a response to that type of query. In this system, there is two-way communication between the various system components to facilitate the transfer of information in order to respond to an information query.

The method of the present invention generally provides a means for a user to catalog clothing items in the user's wardrobe. With this capability, the user can access his or her wardrobe information and use it when deciding to make a new clothing item purchase, when deciding what to pack for a trip or what is culturally acceptable to wear (therefore to pack) when visiting certain places. With the features of the present invention, when the user goes to purchase a new article of clothing, she/he can take a picture of the item and tell the program if the item is a shirt, pants, dress, etc. The program then performs a search of the user's wardrobe and shows the number of items that match the search criteria. For example, if the user were considering the purchase of a new shirt, the user would input information into the program about the style and color of the shirt. The user can also input the type of information the user wants back in the search. For example, the information the program could return for a particular shirt could be that shirt that the user is considering matches 6 out of 20 ties, 2 out of 10 pairs of pants, and 3 out of 3 pairs of shoes that the user owns. The logic for “matching” would be preprogrammed and updatable based on downloaded information.

When the user packs for a business trip, she/he can enter the destination and the number of outfits required for the trip. The user can also enter other information about the destination of the trip. The method of the invention then calculates the optimal choices based on one or a combination of the information received from the user. The information submitted by the user can be based on the following queries and preferences:

A. Having as many “cross matches” as possible, to make dressing up in the hotel easier.

B. The expected weather (either from a database of climatic information, or getting a weather forecast through the network).

C. Cultural requirements. A Japanese shirt with a manji would be inappropriate anywhere in the west and highly inappropriate in Israel or Germany, since a manji is a swastika. Wearing blue and white might be inappropriate anywhere in the Arab world, since those are the colors of the Israeli flag.

Referring the FIG. 5, shown are the general steps in the implementation of the present invention. Initially, a user profile is created and stored in a wardrobe database in step 510. This profile will consist of a record for each clothing item a user wants to include in their wardrobe. A user can access the system of the present invention and indicate a desire to create or modify a user profile. Upon receiving an indication of a desire to create or modify a user profile, the method of the present invention will prompt the user to enter information about each clothing item. For example, if a user was at a computer terminal, the user may receive information such as shown in FIG. 2. Also displayed may be a series of blank records in which the user could input information about each clothing item in accordance with the various codes shown in FIG. 2. For example, as previously discussed, the records in FIG. 3 could be a user's wardrobe profile. This profile would initially contain 12 clothing item records. If not sorted by the user, an internal sorting process could sort the clothing articles according to their item numbers. At this point, the user profile stored in the database could be arranged similar FIG. 3.

Referring to FIG. 5, in step 512, an inquiry is received from a user. Step 514 then identifies the search criteria. This criterion could be in a format similar to a database record. For example, a user may choose to enter codes 4, 3 and 4. The user may also choose to leave certain fields blank and thereby widen the search. Here the first 4 could be the item, 3 could be the color and the second 4 could be the style. With the other fields being blank, the search criteria would be a gray, pullover, and long sleeve shirt. Another approach is to have identification tags on the clothing articles. For example, RFID tags that contain inventory information about items. The information from these tags can be scanned by the user and transmitted to the processing center. Step 516 would perform a search of the data for clothing articles that match the search criteria. Using the database of FIG. 3, there would be one record that matches these search criteria. Step 518 would generate a response to the query showing the item(s) that found during the search.

FIG. 6 is an example of the steps in the method of the present invention when planning a wardrobe for a trip. In this method, step 610 receives a query from a user. This query can contain information indicating that the query is for trip. Another approach can be for the user to receive a prompt to indicate the kind of search that the user desires. The user would then enter the appropriate information such as the destination, the length of the trip in days and the number of outfits the user may require. Step 612 would receive the information and identify the number of outfits needed for the trip. Step 614 would perform a search of the user profile database for outfits that match the trip requirements. For example, if the trip was a business trip and the weather for that location is snowy, the search may look for dress (button down long sleeve) shirts or pullover long sleeve shirts. Step 616 would take the matches from 614 and generate clothing item combinations (such as matching pants and shirts). These combinations would be submitted to the user.

FIG. 7 is a flow diagram of a detailed implementation of the method of the present invention when the cultural norms of a particular location are a consideration when selecting the clothing articles to take on a trip. A user profile is created and stored in a database in step 710. When a user submits a query, step 712 receives a query and identifies the criteria that will be the subject of the query. The next step 714 examines the criteria and determines if there are culture requirements in the criteria. As with previously discussed methods, there can be an indicator in the criteria that there are culture requirements as part of the search. One such indicator can be a character in a field. Another indicator can be a response to a prompt from the method. If the determination is that there are no cultural requirements with this query, the method moves to step 725. In this step, the search is performed on the user database profile based on the search criteria other than the culture requirements of an identified location. The search attempts to find clothing items in the user's profile that match the identified criteria.

Referring to step 714, if there is a determination that there are cultural requirements that are part of the search criteria, then the method moves to step 716. This step identifies the particular cultural requirements for the search. The cultural requirements may be identified from a set of cultural rules that are contained in the cultural practices module 460. For example, there may be a rule that says this culture has a practice of wearing green on March 17^{th}. If the user will be traveling to this culture during the time of March 17^{th}, this rule or practice would influence the results of the search. The search would consider the color of a clothing item in response to the cultural practice of the location where the user will visit.

Referring again to FIG. 7, step 718 performs a search of the user database profile using the identified cultural requirements. As mentioned, applying cultural rules identified from the cultural practices module 460 can perform this search. Step 720 determines whether the search has been completed and if there are any clothing items that match the search criteria. If the search process examines each record in the user profile and there are no clothing items that match the search criteria, step 722 sends a no results message to the user and the method moves to step 725. If in step 720, there are clothing items that match the search criteria, step 724 can temporarily store these matches. As mentioned, in step 725, a search is performed on the stored results from the search in step 718 based on the search criteria other than the culture requirements of an identified location. The search attempts to find clothing items from the initial search that match the identified criteria.

Step 726 makes a determination of whether there are any matches from the search. For example, if one of the cultural matches was a long sleeve shirt and the weather for that location is warm, this long sleeve shirt may not match the weather criteria. If a result from the first culture search was a pair of brown Khaki pants and this clothing item was within the cultural requirements, this item would be stored as a match. The cultural search could have the affect of eliminating certain clothing items that are not desirable or identifying certain items that are desirable in that culture. Clothing items that do not fall in either the undesirable or desirable categories are viewed as matches for the initial search based on culture. Khaki pants could be an example of clothing that does not fall in either category, therefore it is considered a match. If step 726 does not produce any matches, a no result message is sent to the user informing the user that there were no matches. If in step 726, there are matches, these matches are also identified in step 730. These matches can be shown to the user in step 732. If from step 726, there are no matches, then the matches stored in step 724 are displayed to the user in step 732.

In addition, there can be steps to determine whether there are desirable combination matches among the clothing items identified in step 726. Rules that define what are considered to be combination matches can be stored and used to determine these combination matches. If there are combination matches, these matches are also identified in step 730. These combination matches can be shown to the user in step 732.

When dressing, the user can take a picture of an item to see which items match it, or take pictures several items to check if they match. Services offered by vendors might be downloadable packages of targeted appropriate attire. Eg. Fashionista, Conservative, Business-appropriate attire. For many, this would allow adherence to societal norms where no knowledge in this area previously existed. This invention might be further tuned to allow input on the sort of clientele or friends one might be meeting and to offer further advice on the chosen clothing selection. Optional add-ons include downloadable current fashion profiles. Suggestions and alternatives might be provided. Additionally this can serve as a fashion “sanity check” to be compared with immediately downloaded latest fashion trends. As in “those boots go with all your jeans, but boots are out for fall”.

This solution uses a cellular telephone with a camera to identify colors, and then a database (either local or on a remote server) to match them. This solution seeks to aid people in: a) matching items of clothing, one to another; b) matching clothes which they are considering purchasing, with those in their existing wardrobes; c) informing them during the purchase cycle as to fashion trends.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for selecting articles of clothing comprising the steps of:
storing a created user profile in a database;
receiving a query from a user requesting a search of the requesting user's profile;
identifying search criteria from the user's request;
identifying a type of search request by determining whether a search request is based on a search type such as cultural requirements, weather conditions, a purchase of a clothing item or a combination searching the user profile based on the search criteria; and
generating a response to the query based on search results.

2. The method as described in claim 1 wherein a user request is related to the potential purchase of an article of clothing.

3. The method as described in claim 1 further comprising the step of storing cultural rules in a database these rules describing articles of clothing that are acceptable to wear and articles of clothing that are not acceptable to wear in an identified culture.

4. The method as described in claim 3 wherein said user request is related to the selection of articles of clothing based on cultural rules of a specified location.

5. The method as described in claim 3 wherein said user profile searching step further comprises the steps of:
identifying a specific culture related to the user request;
applying rules from the specified culture to clothing items in the user profile; and
identifying clothing items that match the search criteria and comply with specified cultural rules.

6. The method as described in claim 5 further comprising after said clothing articles identifying step, the step of storing clothing article matches in a temporary storage medium.

7. The method as described in claim 6 further comprising after said temporary storage step, the step of determining whether there are combination matches between the identified articles of clothing, the combination matches being matches between various types of clothing articles.

8. The method as described in claim 1 wherein said user profile searching step further comprises the steps of:
identifying a specific culture related to the a user request;
accessing cultural information related to a culture specified in the search criteria, from a source outside the database;
applying information retrieved from the outside source to clothing items in the user profile; and
identifying clothing items that match the search criteria and that comply with specified information about the identified culture.

9. The method as described in claim 8 wherein said applying step further comprises in addition to applying information retrieved from the outside source to clothing items in the user profile, applying rules stored in a database about a specified culture to clothing items in the user profile

10. A method for selecting articles of clothing according the cultural norms comprising the steps of:
receiving a query from a user requesting a search of a requesting user's profile;
determining whether the query has culture based criteria;
identifying cultural criteria, when there is a determination that there are culture based criteria;
searching the user profile based on the search criteria; and
generating a response to the query based on search results.

11. The method as described in claim 10 further comprising before said receiving query step, the step of storing cultural rules in a database, these rules describing articles of clothing that are acceptable to wear and articles of clothing that are not acceptable to wear in an identified culture.

12. The method as described in claim 11 wherein said user profile searching step further comprises the steps of:
identifying a specific culture related to the user request;
applying rules from the specified culture to clothing items in the user profile; and
identifying clothing items that match the search criteria and comply with specified cultural rules.

13. The method as described in claim 12 wherein said profile-searching step further comprises after said identifying clothing items that match search criteria step, the steps of:
storing search results based on identified cultural criteria;
searching the stored search results applying identified search criteria that is not culture-based criteria.

14. The method as described in claim 13 wherein additional search criteria is criteria related to weather of a desired location.

15. A system for selecting articles of clothing according the cultural norms comprising:
a user interface;
a search-processing center for receiving user queries and performing search requests;
a database containing information about clothing items in a user's wardrobe;
a communication network to enable a user to submit requests through the user interface to the search-processing center;
a directory within the database containing information about clothing articles in the user profile;
subdirectories within the directory, for each of clothing article in the user profile; and
a cultural practices module containing rules that govern cultural norms for wearing clothing articles in a specified culture.

16. The system as described in claim 15 further comprising information sources other than the cultural practices modules.

17. The system as described in claim 16 wherein said information source other than a cultural practices module is an weather information resource.

18. A computer program product stored in a computer readable storage medium for selecting articles of clothing according the cultural norms comprising:
instructions receiving a query from a user requesting a search of a requesting user's profile;
instructions determining whether the query has culture based criteria;
instructions identifying cultural criteria, when there is a determination that there are culture based criteria;
instructions searching the user profile based on the search criteria; and
instructions generating a response to the query based on search results.

19. The computer program product as described in claim 18 further comprising before said receiving query instructions, instructions storing cultural rules in a database, these rules describing articles of clothing that are acceptable to wear and articles of clothing that are not acceptable to wear in an identified culture.

20. The computer program product as described in claim 19 wherein said user profile searching instructions further comprise:
instructions identifying a specific culture related to the user request;
instructions applying rules from the specified culture to clothing items in the user profile; and
instructions identifying clothing items that match the search criteria and comply with specified cultural rules.
